(19) United States
(12) Patent Application Publication
(10) Pub. No.: US 2026/0360035 A1
(43) Pub. Date: Nov. 12, 2026

(54) REGION CUTOUT FROM PROMPT

(71) Applicant: Snap Inc., Santa Monica, CA (US)

(72) Inventors: Avihay Assouline, Tel Aviv (IL); Itamar Berger, Hod Hasharon (IL); Amir Fruchtman, Holon (IL); Peleg Harel, Ramat Gan (IL); Jonathan Heimann, Herzliya (IL); Gideon Rubin, Jerusalem (IL)

(21) Appl. No.: 19/205,802

(22) Filed: May 12, 2025

(51) Int. Cl. G06T 11/60; G06F 40/40; G06T 7/12; G06T 11/65; H04N 23/63

(52) U.S. Cl. CPC G06T 11/60; G06F 40/40; G06T 7/12; G06T 11/65; G06T 2200/24; G06T 2207/20132; G06T 2210/22; H04N 23/632

(57) ABSTRACT

A system for generating a cutout in a rendered image is described. The system receives a text prompt and a cutout shape as input, the text prompt describing a scene and the cutout shape defining one or more regions for inserting one or more images into the scene. The system generates, using a final image generator model with the text prompt and the cutout shape, a final image corresponding to the scene described by the text prompt and having one or more regions configured to incorporate the one or more images based on the cutout shape. The system enables placement of the one or more images into the one or more regions of the final image.

### TECHNICAL FIELD

The present disclosure relates to computer graphics technologies and specifically to generative rendering engines for generating digital effects on user devices.

### BACKGROUND

Some electronics-enabled devices, such as eyewear devices, allow users to interact with virtual content (e.g., augmented reality (AR) objects or other digital effects) while a user is engaged in some activity. The virtual content can be part of a digital effects application that presents such objects over a real-world environment. Current rendering engines for computer graphics rely on physics-based principles, requiring extensive three-dimensional (3D) modeling, animation, and rigging, which is time-consuming and demands multiple experts. This traditional approach limits the ability to create highly realistic images and videos in real time. Additionally, existing systems often require sophisticated tracking and recognition technology (which itself is imperfect), complicating the creation of realistic content.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a digital interaction system that has both client-side and server-side functionality, according to some examples.

FIG. 3 is a diagrammatic representation of a data structure as maintained in a database, according to some examples.

FIG. 4 is a diagrammatic representation of a message, according to some examples.

FIG. 5 illustrates a diagram of a digital effects experience generation system, according to some examples.

FIG. 6 illustrates a more detailed diagram of the digital effects experience generation system, according to some examples.

FIG. 7 is a diagram of example inputs and outputs of the digital effects experience generation system, according to some examples.

FIG. 8 is a flowchart illustrating a routine (e.g., a method or process), according to some examples.

FIG. 9 illustrates a system including the head-wearable apparatus, according to some examples.

FIG. 10 is a diagrammatic representation of a machine in the form of a computer system within which a set of instructions may be executed to cause the machine to perform any one or more of the methodologies discussed herein, according to some examples.

FIG. 11 is a block diagram showing a software architecture within which examples may be implemented.

### DETAILED DESCRIPTION

The description that follows discusses illustrative examples of the disclosure. In the following description, for the purposes of explanation, numerous specific details are set forth to provide an understanding of various examples of the disclosed subject matter. It will be evident, however, to those skilled in the art, that examples of the disclosed subject matter may be practiced without these specific details. In general, well-known instruction instances, protocols, structures, and techniques are not necessarily shown in detail.

Conventional AR systems for object and facial modifications rely heavily on pre-built assets and manual creation processes that are highly inefficient. These systems usually require artists and designers to individually craft each overlay asset, manually adjusting parameters and alignment for different facial features. The conventional technical approach maintains separate pre-built models and assets for each type of facial effect, leading to redundant storage and processing overhead. Rather than dynamically generating modifications, these systems dedicate significant resources to storing and managing individual assets for every possible variation. The technical infrastructure wastes processing power by requiring separate tracking and alignment calculations for each pre-built overlay.

From a computational perspective, conventional systems create unnecessary duplicate processing paths by maintaining multiple separate alignment mechanisms for different types of effects. The technical architecture relies on server-side storage and delivery of large asset libraries, consuming excessive network bandwidth and increasing latency. Additionally, these systems need to maintain separate alpha channel and masking data for each individual overlay, resulting in bloated storage requirements and redundant transparency calculations.

Some conventional approaches consume significant computational resources and time to train specialized machine learning (ML) models for each type of visual transformation. These systems need extensive datasets and lengthy training periods to develop models that can handle specific modifications like facial expressions, animal features, or emotional characteristics. The training process usually needs to be repeated separately for each new type of transformation, creating redundant effort and computational overhead. Additionally, these trained models are typically inflexible and cannot be easily adapted to new types of modifications without complete retraining.

The disclosed examples improve the efficiency of using the electronic device by eliminating the need for pre-built window cutout images through dynamic generation based on text prompts and cutout shapes. This can reduce computational overhead by, in some cases, using a dual-pipeline image generation approach that first creates an initial image with lighter enforcement of the cutout shape followed by a second generation with stronger enforcement, enabling real-time processing through efficient edge map generation and combination techniques. The disclosed approach streamlines the modification process by directly converting text descriptions into integrated window cutout images that properly align with the desired cutout regions.

Specifically, the disclosed examples improve the efficiency of using the electronic device through a sophisticated dual-pipeline image generation process. First, the disclosed system receives a text prompt and cutout shape as input. The text prompt can be enhanced by a large language model (LLM) to include additional descriptive details. The disclosed system then employs a first image generator model to create an initial image with a lighter enforcement of the cutout shape, allowing for natural integration of the scene elements. The technical process continues by generating an edge map (e.g., a canny image) from the initial image using canny edge detection, which effectively creates a pencil-like drawing rather than segmentation. This edge map is then combined with the cutout shape with a stronger level of enforcement, creating a modified edge map that precisely defines the desired regions (e.g., the cutout regions). The disclosed system uses this modified edge map along with the original text prompt as input to a second image generator model, which produces a final image that properly integrates the content with the cutout shape. The process incorporates control mechanisms at multiple stages, first during the initial generation with lighter enforcement of the cutout shape, and then during the second generation phase where the shape is more strongly enforced through the modified edge map.

This approach enables real-time processing by efficiently managing the generation pipeline and allows for precise control over the placement and integration of cutout regions while maintaining artistic coherence with the surrounding scene. The system can further enhance efficiency by utilizing scribble representations of the cutout shape as input to influence the arrangement of scene elements, and by applying contextual information to ensure the generated images align with the desired style and characteristics.

As referred to herein, “canny image” is a representation of an image that has been converted into a pencil-like drawing that shows the edges and borders of the image elements, rather than using image segmentation. The canny process (which can be implemented by one or more ML models) creates line drawings that outline the boundaries and details within the image. This edge detection technique is specifically used in the window cutout process to create edge maps that can be combined with cutout shapes to define cutout regions more precisely in the image generation pipeline.

The disclosed examples increase the efficiencies of the electronic device by reducing the amount of information and inputs needed to accomplish a task and reducing running complex image processing algorithms on the AR device. The disclosed examples further increase the efficiency, appeal, and utility of electronic AR devices, such as eyewear devices. While the disclosed examples are provided within a context of electronic eyewear devices, similar examples can be applied to any other type of AR wearable device, such as an AR hat, an AR watch, an AR belt, an AR ring, an AR bracelet, AR earrings, and/or an AR headset or other device that allows users to control or interact with content and/or an object presented on a video or image.

### Networked Computing Environment

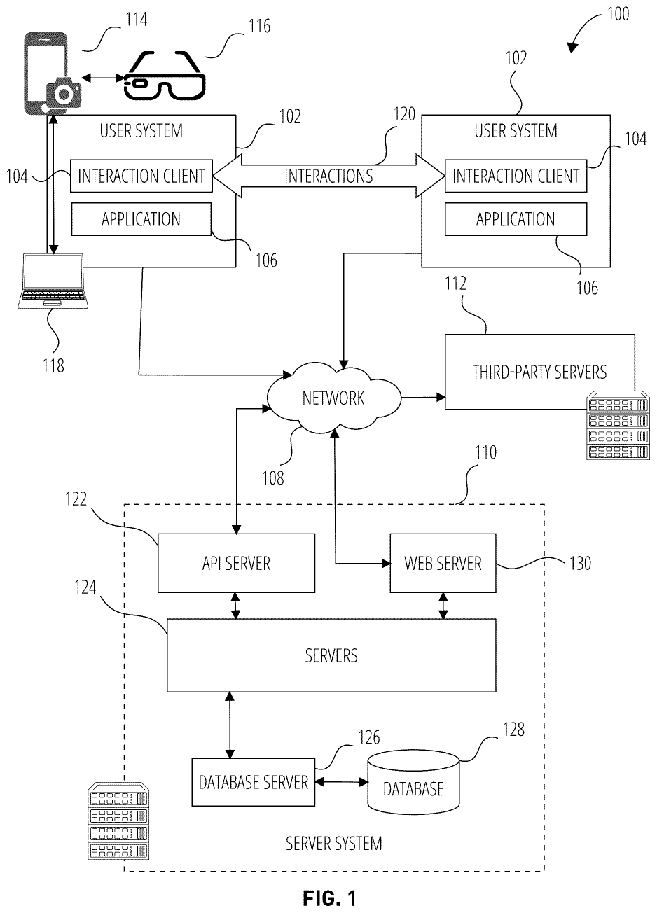

FIG. 1 is a block diagram showing an example digital interaction system 100 for facilitating interactions and engagements (e.g., exchanging text messages, conducting text audio and video calls, or playing games) over a network. The digital interaction system 100 includes multiple user systems 102 (e.g., user devices) and/or head-wearable apparatus 116, each of which hosts multiple applications, including an interaction client 104 and other applications 106. Each interaction client 104 is communicatively coupled, via one or more networks including a network 108 (e.g., the Internet), to other instances of the interaction client 104 (e.g., hosted on respective other user systems 102), a server system 110 and third-party servers 112. An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 includes functions (e.g., commands to invoke functions) and payload data (e.g., text, audio, video, or other multimedia data).

The server system 110 provides server-side functionality via the network 108 to the interaction clients 104. While certain functions of the digital interaction system 100 are described herein as being performed by either an interaction client 104 or by the server system 110, the location of certain functionality either within the interaction client 104 or the server system 110 may be a design choice. For example, it may be technically preferable to initially deploy particular technology and functionality within the server system 110 but to later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, client device information, geolocation information, digital effects (e.g., media augmentation and overlays), message content persistence conditions, entity relationship information, and live event information. Data exchanges within the digital interaction system 100 are invoked and controlled through functions available via user interfaces of the interaction clients 104.

Turning now specifically to the server system 110, an API server 122 is coupled to and provides programmatic interfaces to servers 124, making the functions of the servers 124 accessible to interaction clients 104, other applications 106 and third-party servers 112. The servers 124 are communicatively coupled to a database server 126, facilitating access to a database 128 that stores data associated with interactions processed by the servers 124. Similarly, a web server 130 is coupled to the servers 124 and provides web-based interfaces to the servers 124. To this end, the web server 130 processes incoming network requests over the Hypertext Transfer Protocol (HTTP) and several other related protocols.

The API server 122 receives and transmits interaction data (e.g., commands and message payloads) between the servers 124 and the user systems 102 (and, for example, interaction clients 104 and other application 106) and the third-party server 112. Specifically, the API server 122 provides a set of interfaces (e.g., routines and protocols) that can be called or queried by the interaction client 104 and other applications 106 to invoke functionality of the servers 124. The API server 122 exposes various functions supported by the servers 124, including account registration; login functionality; the sending of interaction data, via the servers 124, from a particular interaction client 104 to another interaction client 104; the communication of media files (e.g., images or video) from an interaction client 104 to the servers 124; the settings of a collection of media data (e.g., a narrative); the retrieval of a list of friends of a user of a user system 102; the retrieval of messages and content; the addition and deletion of entities (e.g., friends) to an entity relationship graph (e.g., the entity graph 308); the location of friends within an entity relationship graph; and opening an application event (e.g., relating to the interaction client 104).

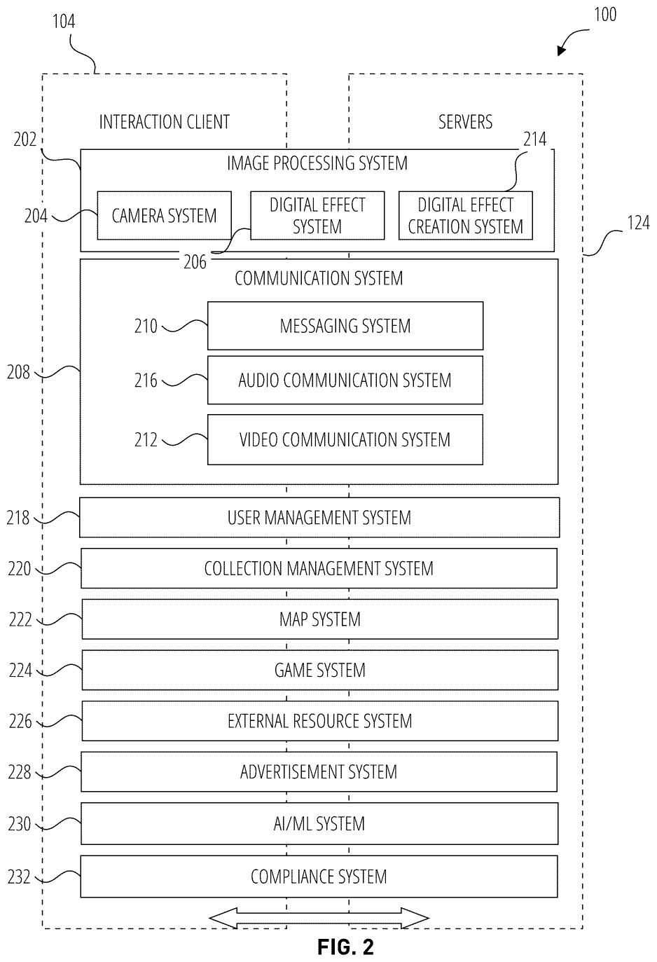

The servers 124 host multiple systems and subsystems, described below with reference to FIG. 2.

### External Resources and Linked Applications

The interaction client 104 provides a user interface that allows users to access features and functions of an external resource, such as a linked application 106, an applet, or a microservice. This external resource may be provided by a third party or by the creator of the interaction client 104.

The external resource may be a full-scale application installed on the user system 102, or a smaller, lightweight version of the application, such as an applet or a microservice, hosted either on the user's system or remotely, such as on third-party servers 112 or in the cloud. These smaller versions, which include a subset of the full application's features, may be implemented using a markup-language document and may also incorporate a scripting language and a style sheet.

When a user selects an option to launch or access the external resource, the interaction client 104 determines whether the resource is web-based or a locally installed application. Locally installed applications can be launched independently of the interaction client 104, while applets and microservices can be launched or accessed via the interaction client 104.

If the external resource is a locally installed application, the interaction client 104 instructs the user's system to launch the resource by executing locally stored code. If the resource is web-based, the interaction client 104 communicates with third-party servers to obtain a markup-language document corresponding to the selected resource, which it then processes to present the resource within its user interface.

The interaction client 104 can also notify users of activity in one or more external resources. For instance, it can provide notifications relating to the use of an external resource by one or more members of a user group. Users can be invited to join an active external resource or to launch a recently used but currently inactive resource.

The interaction client 104 can present a list of available external resources to a user, allowing them to launch or access a given resource. This list can be presented in a context-sensitive menu, with icons representing different applications, applets, or microservices varying based on how the menu is launched by the user.

In some cases, the external resources include applications that enable shared or multiplayer digital effect applications or experiences and sessions on one or more head-wearable apparatuses 116. In some examples, the external resources include instructions that define functionality to implement respective digital effects experiences. These instructions can include textual prompts that are processed by local or remote implementations of generative ML models to generate the digital effects experiences, such as by presenting artificially generated or artificially augmented video with one or more digital effects.

The disclosed system improves electronic device efficiency by enabling real-time window cutout generation through a dual-pipeline image generation approach. The system processes text prompts through a LLM to enhance descriptive details and generates window cutout images that properly integrate with desired cutout regions, eliminating the need for storing pre-made window cutout assets. By utilizing a sophisticated two-stage generation process with varying levels of cutout shape enforcement, the system reduces computational overhead compared to conventional approaches. The technical architecture first generates an initial image with lighter enforcement of the cutout shape, followed by edge map generation using canny edge detection that creates pencil-like drawings of image boundaries. This edge map is then combined with the cutout shape under stronger enforcement to create a modified edge map, which guides the second image generation phase. The system enables instant generation and application of custom window cutouts while maintaining artistic coherence, as the dual-pipeline approach ensures proper integration of cutout regions with the surrounding scene.

The system processes these images that can be used to create social media AR experiences, allowing for efficient local rendering of digital effects that incorporate the generated window cutouts. This approach enables real-time processing on devices by efficiently managing the generation pipeline through controlled enforcement levels and precise edge map manipulation.

### System Architecture

FIG. 2 is a block diagram illustrating further details regarding the digital interaction system 100, according to some examples. Specifically, the digital interaction system 100 is shown to comprise the interaction client 104 and the servers 124. The digital interaction system 100 embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each of the other components through well-defined APIs or interfaces, using lightweight protocols such as REST or messaging. The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture.

Example subsystems are discussed below.

An image processing system 202 provides various functions that enable a user to capture and modify (e.g., augment, annotate or otherwise edit) media content associated with a message.

A camera system 204 includes control software (e.g., in a camera application) that interacts with and controls camera hardware (e.g., directly or via operating system controls) of the user system 102 to modify real-time images captured and displayed via the interaction client 104.

A digital effect system 206 provides functions related to the generation and publishing of digital effects (e.g., media overlays) for images captured in real-time by cameras of the user system 102 or retrieved from memory of the user system 102. For example, the digital effect system 206 operatively selects, presents, and displays digital effects (e.g., media overlays such as image filters or modifications) to the interaction client 104 for the modification of real-time images received via the camera system 204 or stored images retrieved from memory 902 of a user system 102. The digital effect system 206 can provide such functions by accessing a set of instructions associated with each respective digital effects experience and processing such instructions by video generative ML models in real time. The generative ML models can continuously process inputs and/or interactions with the rendered digital effects experiences to update presentation of the digital effects provided by the digital effects experiences. These digital effects are selected by the digital effect system 206 and presented to a user of an interaction client 104, based on a number of inputs and data, such as for example:
Geolocation of the user system 102; and
Entity relationship information of the user of the user system 102.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A digital effect(s) application (or digital effects experience or AR experience) is an application configured to provide and display these digital effects and can enable users to engage in multiplayer digital effects sessions using respective head-wearable apparatuses 116 or other user systems 102. The digital effect application can be part of the application 106 (and/or interaction client 104) implemented by the user system 102 and/or the head-wearable apparatus 116. In some cases, the digital effect application or output representing the digital effect application can be rendered by a generative ML model by processing a set of instructions including prompts that define behavior, goals, and attributes of digital effects relative to real-world or virtual items presented in a video or image in real time. This way, rather than using real-time object tracking and modeling, the digital effects can be presented using fewer hardware and software resources by processing the instructions and generating outputs with the generative ML model.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The digital effect creation system 214 supports AR developer platforms and includes an application for content creators (e.g., artists and developers) to create and publish digital effects (e.g., AR experiences) of the interaction client 104. The digital effect creation system 214 provides a library of built-in features and tools to content creators including, for example custom shaders, tracking technology, and templates. Any functionality that is performed by the digital effect creation system 214 can be replaced and/or augmented by processing instructions with or by a generative ML model. In such cases, object tracking and 3D modeling components used by the digital effect creation system 214 can be omitted or skipped as the appropriate output is rendered by the generative ML model.

In some examples, the digital effect creation system 214 provides a merchant-based publication platform that enables merchants to select a particular digital effect associated with a geolocation via a bidding process. For example, the digital effect creation system 214 associates a media overlay of the highest bidding merchant with a corresponding geolocation for a predefined amount of time.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 306, entity graphs 308, and profile data 302) regarding users and relationships between users of the digital interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the digital interaction system 100. The digital interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and supports the provision of in-game rewards (e.g., coins and items).

An external resource system 226 provides an interface for the interaction client 104 to communicate with remote servers (e.g., third-party servers 112) to launch or access external resources, e.g., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes APIs with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to servers 124. The servers 124 can add a visual representation (such as a box art or other graphic) of the web-based external resource in the interaction client 104. Once the user selects the visual representation or instructs the interaction client 104 through a graphical user interface (GUI) of the interaction client 104 to access features of the web-based external resource, the interaction client 104 obtains the HTML5 file and instantiates the resources to access the features of the web-based external resource.

The interaction client 104 presents a GUI (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional (2D) avatars of users with or without different avatar characteristics). As another example, external resources that include small-scale versions of applications (e.g., web-based versions of applications) are provided with access to a second type of user data (e.g., payment information, 2D avatars of users, 3D avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and handles the delivery and presentation of these advertisements.

An artificial intelligence (AI) and ML system 230 provides a variety of services to different subsystems within the digital interaction system 100 including a digital effects experience generation system 502, such as a LLM component 506.

For example, the AI and ML system 230 operates with the image processing system 202 and the camera system 204 to analyze images and extract information such as objects, text, or faces. This information can then be used by the image processing system 202 to enhance, filter, or manipulate images. The AI and ML system 230 may be used by the digital effect system 206 to generate modified content and AR experiences, such as adding virtual objects or animations to real-world images. The AI and ML system 230 can access a set of instructions that define an individual digital effects experience. The AI and ML system 230 can then process such instructions by a generative ML model (in some cases along with additional user supplied inputs and/or videos/images) to render an artificial video that depicts digital effects within a real-world or virtual environment defined by the instructions.

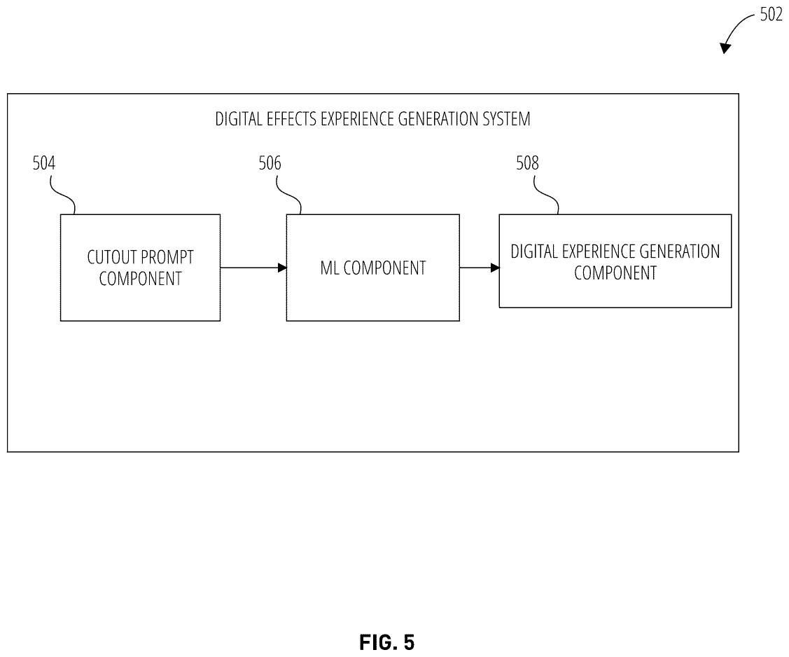

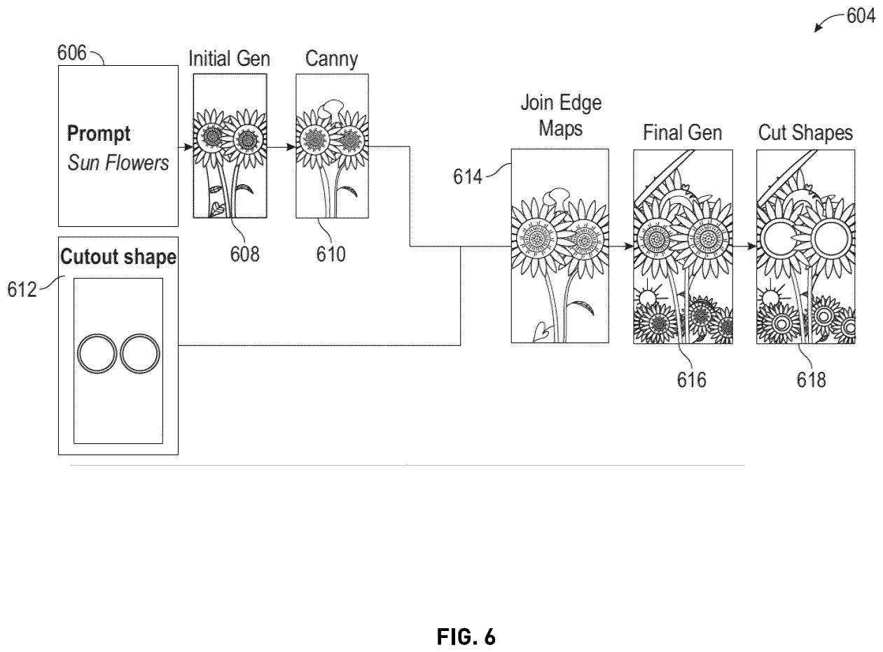

In some cases, the digital effect system 206 and AI and ML system 230 work together to enable efficient real-time window cutout generation through a novel dual-pipeline approach. Rather than maintaining separate trained models, the AI and ML system 230 uses a two-stage generation process that processes text prompts and cutout shapes with varying levels of enforcement. The AI and ML system 230 first generates an initial image with lighter enforcement of the cutout shape while maintaining artistic integration with the scene. The AI and ML system 230 then employs canny edge detection to create a pencil-like drawing showing the boundaries of the initial image, which is combined with the cutout shape under stronger enforcement to create a modified edge map. A second image generator model processes this modified edge map along with the original text prompt to produce a final image that properly integrates the content with the cutout regions. This architecture enables the AI and ML system 230 to efficiently generate window cutouts by using a language model to enhance text prompts with additional descriptive details and employing controlled enforcement levels during the dual-pipeline process. The AI and ML system 230 processes these elements through specialized components (e.g., discussed in more detail below in connection with FIG. 5 and FIG. 6) that convert the final images into AR experiences for social media applications, allowing for efficient generation of window cutouts while maintaining artistic coherence between the cutout regions and surrounding scene. This technical approach enables rapid generation and application of custom window cutouts while minimizing computational overhead by efficiently managing the generation pipeline through controlled enforcement levels and precise edge map manipulation rather than requiring separate models for each effect type.

Machine learning is a field of study that gives computers the ability to learn without being explicitly programmed. The AI and ML system 230 can be built using ML models. Machine learning (e.g., ML models) explores the study and construction of algorithms, also referred to herein as tools, that may learn from existing data and make predictions about new data. Such machine-learning tools operate by building a model from example training data in order to make data-driven predictions or decisions expressed as outputs or assessments. Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), neural networks (NNs), matrix factorization, and Support Vector Machines (SVM) tools may be used for classifying or scoring job postings.

Two common types of problems in ML are classification problems and regression problems. Classification problems, also referred to as categorization problems, aim at classifying items into one of several category values (for example, is this object an apple or an orange?). Regression algorithms aim at quantifying some items (for example, by providing a value that is a real number). The machine-learning algorithms use features for analyzing the data to generate an assessment. Each of the features is an individual measurable property of a phenomenon being observed. The concept of a feature is related to that of an explanatory variable used in statistical techniques such as linear regression. Choosing informative, discriminating, and independent features is important for the effective operation of the pattern recognition, classification, and regression. Features may be of different types, such as numeric features, strings, and graphs.

In one example, the features may be of different types and may include one or more of content, concepts, attributes, historical data, and/or user data, merely for example. The machine-learning algorithms use the training data to find correlations among the identified features that affect the outcome or assessment. In some examples, the training data includes labeled data, which is known data, for one or more identified features and one or more outcomes, such as detecting communication patterns, detecting the meaning of the message, generating a summary of a message, detecting action items in messages detecting urgency in the message, detecting a relationship of the user to the sender, calculating score attributes, calculating message scores, detecting an error in an uncorrected gaze vector, etc.

With the training data and the identified features, the machine-learning tool is trained during machine-learning program training. The machine-learning tool appraises the value of the features as they correlate to the training data. The result of the training is the trained machine-learning program. When the trained machine-learning program is used to perform an assessment, new data is provided as an input to the trained machine-learning program, and the trained machine-learning program generates the assessment as output.

The machine-learning program supports two types of phases, namely a training phase and prediction phase. In training phases, supervised learning, unsupervised learning, or reinforcement learning may be used. For example, the machine-learning program (1) receives features (e.g., as structured or labeled data in supervised learning) and/or (2) identifies features (e.g., unstructured or unlabeled data for unsupervised learning) in training data. In prediction phases, the machine-learning program uses the features for analyzing query data to generate outcomes or predictions (as examples of an assessment).

In the training phase, feature engineering is used to identify features and may include identifying informative, discriminating, and independent features for the effective operation of the machine-learning program in pattern recognition, classification, and regression. In some examples, the training data includes labeled data, which is known data for pre-identified features and one or more outcomes. Each of the features may be a variable or attribute, such as individual measurable property of a process, article, system, or phenomenon represented by a data set (e.g., the training data).

In training phases, the machine-learning program uses the training data to find correlations among the features that affect a predicted outcome or assessment. With the training data and the identified features, the machine-learning program is trained during the training phase at machine-learning program training. The machine-learning program appraises values of the features as they correlate to the training data. The result of the training is the trained machine-learning program (e.g., a trained or learned model).

Further, the training phases may involve ML, in which the training data is structured (e.g., labeled during preprocessing operations), and the trained machine-learning program implements a relatively simple NN capable of performing, for example, classification and clustering operations. In other examples, the training phase may involve deep learning, in which the training data is unstructured, and the trained machine-learning program implements a deep NN that is able to perform both feature extraction and classification/clustering operations.

A NN generated during the training phase, and implemented within the trained machine-learning program, may include a hierarchical (e.g., layered) organization of neurons. For example, neurons (or nodes) may be arranged hierarchically into a number of layers, including an input layer, an output layer, and multiple hidden layers. Each of the layers within the NN can have one or many neurons, and each of these neurons operationally computes a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which define the influence of the input from a transmitting neuron to a receiving neuron.

In some examples, the NN may also be one of a number of different types NNs, including a single-layer feed-forward network, an Artificial Neural Network (ANN), a Recurrent Neural Network (RNN), a symmetrically connected NN, and unsupervised pre-trained network, a Convolutional Neural Network (CNN), and/or a Generative Adversarial Network (GAN), merely for example.

During prediction phases, the trained machine-learning program is used to perform an assessment. Query data is provided as an input to the trained machine-learning program, and the trained machine-learning program generates the assessment as output, responsive to receipt of the query data.

The NN architecture implemented for window cutout generation includes specialized components that work together in a dual-pipeline approach to generate integrated images with cutout regions. The system processes text prompts through a language model to enhance descriptive details and employs two image generation stages with varying levels of cutout shape enforcement. In the first phase, an initial image generator model creates images that naturally integrate with the desired cutout regions while maintaining artistic coherence with the scene. The system then employs canny edge detection to create pencil-like drawings showing image boundaries, which are combined with the cutout shape under stronger enforcement to create modified edge maps. In the generation phase, when processing new user inputs, a second image generator model analyzes the modified edge map along with the original text prompt to produce final images that properly integrate content with the cutout regions. The model can handle various cutout shapes, including hearts, circles, stars, and custom user-defined shapes, by learning to adapt the generated images while maintaining artistic integration. The generation process incorporates techniques for handling different contextual information and style characteristics, allowing the system to work effectively with various scene types while ensuring consistent and high-quality integration of the cutout regions. In some cases, the cutout shapes can be defined by another textual prompt and generated by another AI and ML system 230, such as a generative model.

The communication system 208 and messaging system 210 may use the AI and ML system 230 to analyze communication patterns and provide insights into how users interact with each other and provide intelligent message classification and tagging, such as categorizing messages based on sentiment or topic. The AI and ML system 230 may also provide chatbot functionality to message interactions 120 between user systems 102 and between a user system 102 and the server system 110. The AI and ML system 230 may also work with the audio communication system 216 to provide speech recognition and natural language processing capabilities, allowing users to interact with the digital interaction system 100 using voice commands.

A compliance system 232 facilitates compliance by the digital interaction system 100 with data privacy and other regulations, including for example the California Consumer Privacy Act (CCPA), General Data Protection Regulation (GDPR), and Digital Services Act (DSA). The compliance system 232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 232 also incorporates opt-in/opt-out management and privacy controls across the digital interaction system 100, empowering users to manage their data preferences. The compliance system 232 is designed to handle sensitive data by obtaining explicit consent, implementing strict access controls and in accordance with applicable laws.

### Data Architecture

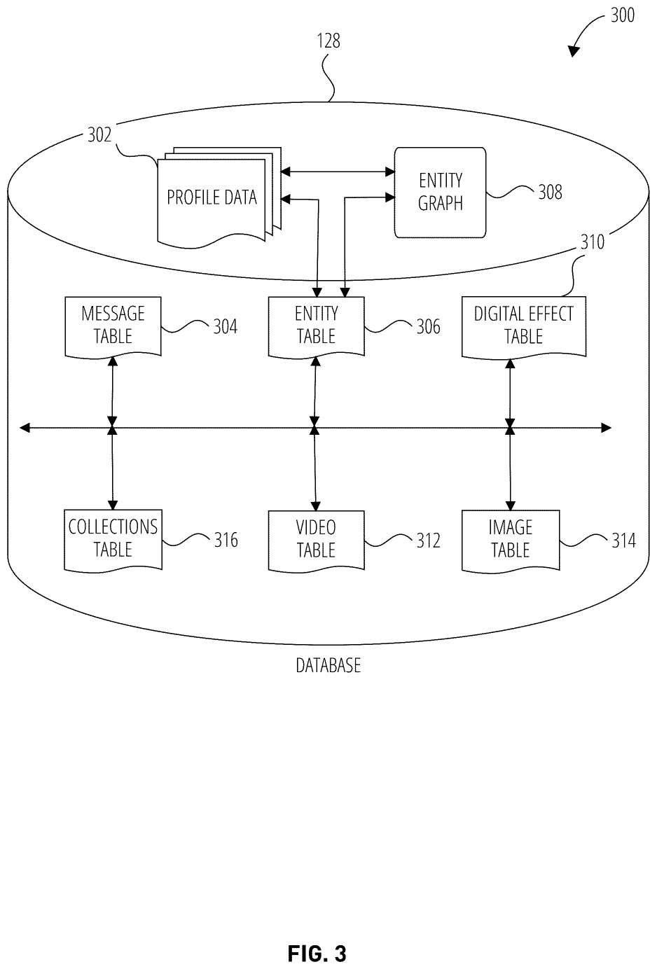

FIG. 3 is a schematic diagram illustrating data structures 300, which may be stored in the database 128 of the server system 110, according to certain examples. While the content of the database 128 is shown to comprise multiple tables, it will be appreciated that the data could be stored in other types of data structures (e.g., as an object-oriented database).

The database 128 includes message data stored within a message table 304. This message data includes at least message sender data, message recipient (or receiver) data, and a payload. Further details regarding information that may be included in a message, and included within the message data stored in the message table 304, are described below with reference to FIG. 3.

An entity table 306 stores entity data, and is linked (e.g., referentially) to an entity graph 308 and profile data 302. Entities for which records are maintained within the entity table 306 may include individuals, corporate entities, organizations, objects, places, events, and so forth. Regardless of entity type, any entity regarding which the server system 110 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 100.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 306. Such privacy settings may be applied to all types of relationships within the context of the digital interaction system 100, or may selectively be applied to certain types of relationships.

The profile data 302 stores multiple types of profile data about a particular entity. The profile data 302 may be selectively used and presented to other users of the digital interaction system 100 based on privacy settings specified by a particular entity. Where the entity is an individual, the profile data 302 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 128 also stores digital effect data, such as overlays or filters, in a digital effect table 310. The digital effect data is associated with and applied to videos (for which data is stored in a video table 312) and images (for which data is stored in an image table 314).

The database 128 stores various types of data including message data in a message table, entity data in entity tables, profile data, digital effect data, such as for the digital effects experience generation system 502, and ML model training data. Specifically, the database 128 can store data elements that enable the real-time visual modification system, such as digital effect system 206, to function efficiently.

The database 128 maintains window cutout experience data including libraries of predefined cutout shapes such as hearts, circles, stars, and custom user-defined shapes. For text prompt and image generation data, the database 128 stores enhanced text prompts generated by the LLM that include additional descriptive details related to the scene. The image generation capabilities are supported by storing edge maps created through canny edge detection that show pencil-like drawings of image boundaries, modified edge maps that combine the cutout shapes with stronger enforcement levels, and the resulting integrated images. The database 128 can also contain specialized AR experience data including different window cutout configurations, contextual information for maintaining artistic coherence, and style characteristics that determine visual elements of the generated images. The system stores data related to the dual-pipeline generation process, including parameters for controlling enforcement levels during initial and secondary image generation phases, ensuring proper integration of cutout regions with the surrounding scene.

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other digital effect data (e.g., instructions that define one or more digital effects experiences) that may be stored within the image table 314 includes AR content items (e.g., corresponding to AR experiences). An AR content item may be a real-time special effect and sound that may be added to an image or a video.

A collections table 316 stores data regarding collections of messages and associated image, video, or audio data, which are compiled into a collection (e.g., a narrative or a gallery). The creation of a particular collection may be initiated by a particular user (e.g., each user for which a record is maintained in the entity table 306). A user may create a “personal collection” in the form of a collection of content that has been created and sent/broadcast by that user. To this end, the user interface of the interaction client 104 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 104, to contribute content to a particular live collection. The live collection may be identified to the user by the interaction client 104, based on his or her location.

A further type of content collection is known as a “location collection,” which enables a user whose user system 102 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

As mentioned above, the video table 312 stores video data that, in some examples, is associated with messages for which records are maintained within the message table 304. Similarly, the image table 314 stores image data associated with messages for which message data is stored in the entity table 306. The entity table 306 may associate various digital effects from the digital effect table 310 with various images and videos stored in the image table 314 and the video table 312.

The databases 128 also include a list of digital effects experiences along with their respective sets of instructions (that define their operation) and/or code that is executed by tracking systems to provide outputs of the digital effects experiences.

### Data Communications Architecture

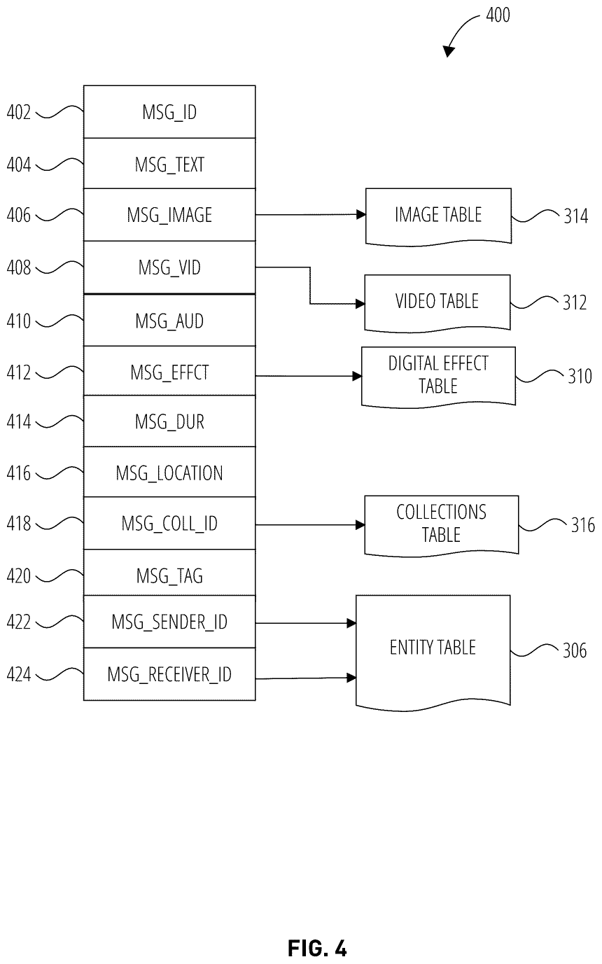

FIG. 4 is a schematic diagram illustrating a structure of a message 400, according to some examples, generated by an interaction client 104 for communication to a further interaction client 104 via the servers 124. The content of a particular message 400 is used to populate the message table 304 stored within the database 128, accessible by the servers 124. Similarly, the content of a message 400 is stored in memory as “in-transit” or “in-flight” data of the user system 102 or the servers 124. A message 400 is shown to include the following example components:
Message identifier 402: a unique identifier that identifies the message 400.
Message text payload 404: text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 314.
Message video payload 408: video data, captured by a camera component or retrieved from a memory component of the user system 102, and that is included in the message 400. Video data for a sent or received message 400 may be stored in the video table 312.
Message audio payload 410: audio data, captured by a microphone or retrieved from a memory component of the user system 102, and that is included in the message 400.
Message digital effect data 412: digital effect data (e.g., filters, stickers, or other annotations or enhancements) that represents digital effects to be applied to message image payload 406, message video payload 408, or message audio payload 410 of the message 400. Digital effect data for a sent or received message 400 may be stored in the digital effect table 310.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal, and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message collection identifier 418: identifier values identifying one or more content collections (e.g., “stories” identified in the collections table 316) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 314. Similarly, values within the message video payload 408 may point to data stored within a video table 312, values stored within the message digital effect data 412 may point to data stored in a digital effect table 310, values stored within the message collection identifier 418 may point to data stored in a collections table 316, and values stored within the message sender identifier 422 and the message receiver identifier 424 may point to user records stored within an entity table 306.

### Digital Effects Experience Generation System

FIG. 5 illustrates a diagram of a digital effects experience generation system 502, according to some examples. The digital effects experience generation system 502 includes a cutout prompt component 504, an ML component 506, and a digital experience generation component 508. The digital effects experience generation system 502 enables real-time modifications of an object depicted in an image or video through several key components that work together to generate an image with one or more cutout regions from text prompts.

Specifically, at the foundation of the digital effects experience generation system 502 is the cutout prompt component 504, which serves as the entry point for user inputs into the digital effects experience generation system 502. This cutout prompt component 504 is responsible for receiving the text prompt and cutout shape, where the text prompt describes a scene (such as “Beautiful forest with two hearts” or “Underwater mermaids”) and the cutout shape defines the regions where images will be inserted. The cutout prompt component 504 processes these inputs and prepares them for further enhancement by the subsequent components in the pipeline.

The cutout prompt component 504 interfaces directly with user systems 102 described in FIG. 1, allowing users to provide input through interaction clients 104. The cutout prompt component 504 enables multiple types of input methods through the interaction clients 104, providing users with flexible ways to describe and create window cutout experiences. For example, text-based scene descriptions allow users to provide natural language prompts through mobile devices 114, head-wearable apparatus 116, and/or computer client devices 118. For instance, a user can input “Beautiful forest with two hearts” to generate a forest scene with heart-shaped windows naturally integrated into the tree line, or “Window cutout of underater mermaids” to create an underwater scene with curved window shapes showing mermaids. In some cases, the prompt can exclude a description of the cutout but instead can supply a cutout shape or description of the desired cutout shape. As another example, visual prompts can be captured through the camera system 204 and image processing system 202. Users can take photos of real-world scenes or objects through their device cameras, which the cutout prompt component 504 can use as reference for generating the window cutout scene. For example, a user could photograph actual sunflowers to inspire the generation of a sunflower-themed window cutout scene. Audio input capabilities are enabled through the audio communication system 216, allowing users to verbally describe their desired scenes. The cutout prompt component 504 can process spoken descriptions like “Create a tropical scene with two star-shaped windows showing parrots” and convert them into appropriate prompts for the generation process.

The interaction clients 104 support multimodal input, where users can combine different input types, such as speaking a scene description while drawing a custom cutout shape on their device screen, or taking a reference photo while typing additional scene details. The ML component 506 processes these various inputs to generate enhanced prompts that guide the image generation process, ensuring high-quality results regardless of the input method.

This cutout prompt component 504 can receive cutout shapes from a library of predefined shapes including hearts, circles, stars, or custom user-defined shapes. Additionally, it can process text prompts of varying complexity, enabling users to describe the desired scene with as much or as little detail as they wish to provide. The cutout prompt component 504 may not only receive predefined and custom cutout shapes, but can also process the cutout shapes through specialized ML models to generate edge maps (e.g., canny images) that precisely define the look and style of the cutout regions. When a cutout shape is received, whether from the library of predefined shapes (hearts, circles, stars) or as a custom user-defined shape, the cutout prompt component 504 processes it through canny edge detection to create a pencil-like drawing showing the boundaries and edges of the shape. This edge map generation process converts the cutout shape into a format that can be effectively combined with other edge maps during the dual-pipeline generation approach. The canny edge detection creates line drawings that outline the boundaries of the cutout shape rather than performing segmentation, allowing for more precise definition of where the cutout regions should be placed.

The ML component 506 can then use these edge map representations of the cutout shapes along with the text prompts to generate images that naturally integrate the cutout regions. The ML component 506 applies varying levels of enforcement to these edge maps, such as using lighter enforcement during initial image generation and stronger enforcement during the final generation phase to ensure proper integration of the cutout regions with the surrounding scene.

For example, the ML component 506 can employ a sophisticated dual-pipeline approach when applying enforcement to edge maps, creating a technical balance between artistic coherence and precise cutout integration. The “enforcement” of the cutout shape refers to the degree of constraint imposed on the image generation model when incorporating the cutout shapes into the scene. This enforcement exists on a spectrum, with technical implementations controlling how strictly the model must adhere to the specified cutout regions during different phases of image generation.

During initial image generation, the ML component 506 applies lighter enforcement to the cutout shapes, which means the image generator model of the ML component 506 is given greater creative freedom while still being guided by the general location and shape of the cutouts. This lighter enforcement is implemented by using the cutout shape as a suggestion rather than a strict requirement, allowing the image generator model to create natural scene elements around the anticipated cutout regions. For example, when generating an image with heart-shaped cutouts in a forest scene, lighter enforcement allows the image generator model to naturally arrange trees, lighting, and other forest elements around where the hearts will be, without being rigidly constrained to specific shapes at this stage. This can be achieved through weaker weights assigned to the cutout shape's influence in the ControlNet architecture, making the image generator model “aware” of the cutout regions without forcing strict adherence.

After generating the initial image, the ML component 506 applies edge detection to create a canny image, such as a pencil-like drawing showing the boundaries of all elements in the generated image. The ML component 506 then combines this edge map with the cutout shape using stronger enforcement, which means the cutout shape is given higher priority and may need to be more precisely followed. For example, when combining the edge map of the forest scene with the heart-shaped cutout, the hearts are overlaid with greater definitional clarity, forcing the image generator model to recognize these regions as non-negotiable boundaries. This can be implemented by assigning higher weights to the cutout shape features during the edge map combination process, ensuring they are not diluted by other detected edges.

In the final generation phase, the stronger enforcement is maintained through the modified edge map, which serves as a more restrictive constraint for the second image generator model (which can be the same or different from the first image generator model). For example, when generating an underwater scene with mermaid cutout shapes, the stronger enforcement ensures that the flowing water elements, coral, and fish are generated specifically around the well-defined cutout regions, which will later accommodate the user's face or content items, such as videos and/or images. The image generator model's loss function can be adjusted to heavily penalize deviations from the enforced cutout boundaries, guaranteeing the structural integrity of these regions in the final output.

The technical benefit of this varying enforcement approach is evident in complex scenes with irregular cutout shapes. For instance, when working with star-shaped cutouts in a night sky scene, lighter initial enforcement allows the image generator model to distribute celestial elements (stars, nebulae, planets) in an aesthetically pleasing arrangement; then stronger enforcement ensures the star-shaped cutouts remain precisely defined without being distorted by surrounding content. Similarly, with custom user-defined shapes like animal silhouettes, the initial lighter enforcement permits the image generator model to creatively integrate the shape outline into the scene composition, while the subsequent stronger enforcement ensures the silhouette remains exact for proper content placement later.

This dual-level enforcement strategy represents a technical improvement that overcomes limitations in existing approaches, particularly in maintaining both artistic coherence and functional cutout precision. Traditional methods either produced rigid, artificial-looking cutouts (using only strong enforcement) or generated natural-looking scenes that failed to preserve proper cutout regions (using only light enforcement). By technically implementing varying levels of enforcement at different stages of the generation pipeline, the ML component 506 achieves the balance, such as creating visually appealing images with seamlessly integrated yet precisely defined cutout regions that can properly accommodate user content. This technical approach of converting cutout shapes into edge maps through canny edge detection enables more precise control over how the shapes are incorporated into the generated images while maintaining artistic coherence between the cutout regions and the surrounding scene elements.

In some examples, the ML component 506 represents the AI and ML capabilities that power the image generation process. The ML component 506 analyzes the text prompt using a LLM and generates an enhanced text prompt that includes additional descriptive details related to the scene. This enrichment process transforms simple user inputs like “sunflowers” into detailed descriptions that guide the image generation process. The ML component 506 leverages the AI and ML system 230 described in FIG. 2, accessing advanced ML models to perform its functions. This ML component 506 is responsible for implementing the dual-pipeline approach, where an initial image is generated with lighter enforcement of the cutout shape, followed by a more strongly enforced second generation phase. The ML component 506 processes the enhanced text prompt and cutout shape to generate the initial image representing the scene.

After generating the initial image, the ML component 506 performs the edge map processing. The ML component 506 processes the initial image to generate an edge map (a canny image), detecting edges within the image and enhancing the definition of these edges along the boundaries of the regions defined by the cutout shape. This processing creates a modified edge map with enhanced definition of the cutout regions, which serves as a key input for the final image generation.

In some examples, the digital experience generation component 508 processes the outputs from the ML component 506 to produce the final image with properly integrated cutout regions. This digital experience generation component 508 (which can be incorporated partially or entirely in the ML component 506) can use the modified edge map to generate a second image that incorporates the regions with stronger enforcement of the cutout shape than in the initial image.

The digital experience generation component 508 works with the digital effect system 206 described in FIG. 2 to create final outputs that can be used in social media experiences. It handles the cropping of the regions according to the cutout shape, creating transparent areas that enable the display of content from a device camera through these areas. This capability allows for the real-time placement of images within the cutout regions.

The digital experience generation component 508 also implements the scribble representation functionality, where a scribble representation of the cutout shape is created and used as input to the final image generator model to influence the arrangement of scene elements around the cutout regions. This technique helps ensure that the generated scene naturally accommodates the cutout regions rather than appearing as if the cutouts were arbitrarily placed after scene generation.

When processing complex scenes, the digital effects experience generation system 502 can handle multiple non-contiguous regions, allowing for the insertion of multiple separate images into different areas of the generated scene. This capability enables more creative and complex compositions, such as creating window cutouts with multiple face placements or different types of content within a single generated image.

For example, the digital effects experience generation system 502 can generate a forest scene with dual heart windows, creating a lush forest environment with two heart-shaped cutout regions naturally integrated among the trees. Live camera feed from the user's device can be displayed through both heart shapes simultaneously, allowing two faces to appear within the scene. The digital effects experience generation system 502 crops the heart-shaped regions according to the cutout shape to create transparent areas that can display real-time camera content through the digital effect system 206.

Another example is an underwater mermaid scene with custom shapes, where an underwater environment with multiple curved window shapes are integrated into the aquatic landscape. Users can place live camera content showing faces through the cutout regions, stored media content selected from their device's library, or a combination of both live and stored content in different regions.

The digital effect system 206 enables real-time placement of different content types while maintaining proper perspective and lighting integration with the underwater scene. The digital effects experience generation system 502 can also create a multi-element scene with interactive regions, generating a complex composition with various shaped cutouts (e.g., stars, circles) distributed throughout the scene. Content integration options include real-time video feeds from the device camera, stored photos or videos from the user's media library, social media content shared through the messaging system 210, and mixed content types across different cutout regions. The digital effects experience generation system 502 processes these content items through the image processing system 202 and camera system 204 to ensure proper scaling, alignment, and integration within each cutout region while maintaining artistic coherence with the surrounding generated scene. The digital effects experience generation system 502 handles the content integration through the digital effect system 206, which enables real-time processing and placement of content within the cutout regions while preserving the artistic integrity of the generated scene. The content can be dynamically updated through the interaction clients 104, allowing users to swap different content items in and out of the cutout regions in real-time.

The entire digital effects experience generation system 502 is designed to operate efficiently on user systems 102, leveraging the processing capabilities of modern devices to enable real-time generation and application of window cutout effects. The digital effects experience generation system 502 processes text prompts through the ML component 506 to enhance descriptive details and generates window cutout images that properly integrate with desired cutout regions, eliminating the need for storing pre-made window cutout assets.

The digital effects experience generation system 502 can generate multiple variations of the final image using the same text prompt and cutout shape, enabling user selection from among these variations. This capability allows users to explore different artistic interpretations of their input, selecting the one that best matches their vision or preferences.

The digital effects experience generation system 502 employs techniques for cropping and integrating images into the cutout regions. When generating variations of a scene, the digital effects experience generation system 502 first creates the base image with integrated cutout shapes, then precisely crops those regions to create transparent areas that can accommodate different types of content. For example, in a forest scene with heart-shaped windows, the digital effects experience generation system 502 carefully crops out the heart regions (from the final image generated by the ML component 506) while preserving the natural integration with surrounding trees and foliage, creating transparent areas that maintain the artistic coherence of the scene.

The cropping process can be handled by the digital effect system 206, which creates transparent areas that can display content from various sources. For an underwater scene with mermaid-shaped cutouts, the digital effect system 206 precisely defines the cutout boundaries using edge maps generated through canny edge detection, ensuring the transparent regions perfectly match the intended shapes while maintaining proper perspective and lighting integration with the surrounding underwater environment. The digital effect system 206 can also handle complex multi-region scenes where different types of content need to be integrated. For instance, in a scene with multiple star-shaped cutouts, each region is individually cropped according to its specific shape while ensuring proper alignment with scene elements. The digital effect system 206 then enables these transparent regions to display various content types, such as from real-time camera feeds to stored media content, while maintaining proper scaling and perspective within each cutout.

The cropping process is particularly sophisticated when handling irregular or custom shapes. The digital effects experience generation system 502 uses the modified edge maps generated during the dual-pipeline process to precisely define the boundaries of these regions, ensuring clean edges that enable seamless content integration. This allows users to explore different artistic interpretations of the same scene while maintaining consistent, high-quality cutout regions that can properly display inserted content.

The digital effects experience generation system 502 integrates with the broader digital interaction system 100 described in FIG. 1, enabling the sharing and distribution of generated window cutout experiences through interaction clients 104. Generated images can be used within messaging applications, shared as part of collections, or incorporated into more complex AR experiences through the digital effect system 206.

The implementation of the digital effects experience generation system 502 provides significant improvements over conventional approaches by enabling efficient real-time generation of window cutout images. Rather than maintaining separate trained models or pre-made assets, the system uses a sophisticated two-stage generation process with varying levels of cutout shape enforcement, reducing computational overhead while maintaining high-quality outputs.

The digital effects experience generation system 502 can also interface with a message table 304 and image table 314 as described in FIG. 3, storing generated images and associated metadata to enable sharing and reuse. Generated window cutout images can be associated with message data, allowing them to be sent as part of messages within the digital interaction system 100.

The digital effects experience generation system 502 can operate as a method or be embodied in a non-transitory computer-readable storage medium storing instructions that cause processors to perform the window cutout generation operations. This flexibility allows the system to be deployed across various platforms and integrated into different software environments.

The digital effects experience generation system 502 represents a significant advancement in the field of image generation for AR applications, providing a streamlined and efficient approach to creating window cutout images that properly integrate cutout regions with surrounding scenes. By leveraging advanced ML techniques and a dual-pipeline generation approach, the system delivers high-quality results while minimizing computational requirements.

Through the combined operations of the cutout prompt component 504, ML component 506, and digital experience generation component 508, the digital effects experience generation system 502 enables users to easily create compelling window cutout experiences from simple text prompts and cutout shapes, opening new creative possibilities for social media and AR applications.

FIG. 6 illustrates a more detailed diagram of the digital effects experience generation system 502, according to some examples. Specifically, FIG. 6 illustrates a detailed diagram 604 of the dual-pipeline image generation process implemented by the digital effects experience generation system 502. This process represents the technical operations for creating window cutout images that seamlessly integrate cutout regions within contextually appropriate scenes. The diagram 604 provides a comprehensive visualization of how the system processes inputs and transforms them through multiple generation stages to produce the final window cutout image.

At the beginning of the process, the cutout prompt component 504 receives a text prompt 606 (shown as “Sun flowers” in the diagram) that describes the desired scene to be generated. This text prompt 606 is processed by the ML component 506, which may enhance the prompt with additional descriptive details to guide the image generation process. The enhanced text prompt, along with a cutout shape 612 (which can itself be defined as a canny image) that defines the regions where content will be inserted, serves as input to the initial image generation phase.

The system generates an initial image 608 using the text prompt and cutout shape with a lighter level of enforcement of the cutout shape. This lighter enforcement allows the system to create a natural-looking scene that accommodates the cutout regions while maintaining artistic coherence with the overall composition. The initial image 608 represents a first-pass interpretation of the scene described by the text prompt, with preliminary consideration given to the placement of the cutout regions.

Following the generation of the initial image 608, the ML component 506 processes this image to create an initial edge map 610. The initial edge map 610 is essentially a pencil-like drawing that outlines the boundaries and significant features of the initial image. Unlike segmentation, which would divide the image into distinct regions, the canny process creates line drawings that highlight the edges and contours present in the image. This edge detection is an important step in the pipeline as it preserves the structural elements of the scene while preparing it for integration with the cutout shape.

The digital effects experience generation system 502 then combines the initial edge map 610 with the cutout shape 612 to create a final edge map 614. This combination process applies a stronger level of enforcement to the cutout shape, ensuring that the regions defined by the cutout shape are precisely delineated within the edge map. The final edge map 614 serves as a sophisticated control mechanism that guides the second generation phase, providing clear boundaries for the cutout regions while maintaining the contextual elements of the surrounding scene.

The final edge map 614, along with the original or enhanced text prompt 606, is then processed by the digital experience generation component 508 to produce a final image 616. This second-pass generation applies stronger enforcement of the cutout regions as defined in the joined edge map, resulting in a final image 616 where the cutout shape is properly integrated with the surrounding scene elements. The final image 616 represents a significant improvement over the initial image in terms of how well the cutout regions are integrated with the rest of the image.

The diagram 604 includes zoomed-in views of the edge maps before and after joining with the cutout shape, highlighting the transformation that occurs during this critical step. Before joining, the edge map shows the natural boundaries and features of the scene. After joining, the cutout shapes are clearly defined and reinforced, ensuring they will be properly preserved in the final image generation. This comparison illustrates how the system progressively refines its understanding and representation of the cutout regions throughout the dual-pipeline process.

The final step shown in the diagram 604 is the creation of the final cutout image 618, where the system crops out the regions defined by the cutout shape. These cropped regions create transparent areas that will later accommodate user content, such as camera feeds or stored media. The final cutout image 618 maintains the artistic integrity of the generated scene while providing precisely defined regions for content insertion.

The technical process depicted in FIG. 6 demonstrates how the digital effects experience generation system 502 manages different levels of enforcement throughout the generation pipeline. The initial generation phase prioritizes the creation of a coherent scene that accommodates the general placement of cutout regions. The edge map processing phase then precisely defines these regions through the joining of the canny edges with the cutout shape. Finally, the second generation phase reinforces these precisely defined regions while maintaining the artistic quality of the overall image.

The implementation shown in FIG. 6 enables efficient processing by focusing computational resources on specific aspects of the generation process at each stage. Rather than attempting to generate a perfect image with properly integrated cutout regions in a single pass, the system breaks the task into targeted steps that progressively refine the output. This approach not only improves the quality of the result but also enhances efficiency by addressing different aspects of the generation challenge separately.

The dual-pipeline process depicted in FIG. 6 can handle various types of cutout shapes, including simple geometric forms like circles and hearts, as well as more complex custom shapes. The process remains consistent regardless of the specific shape used, making it a versatile solution for generating window cutout images across different contexts and applications. This flexibility enables users to create diverse window cutout experiences while maintaining high-quality results.

The diagram 604 illustrates how the digital effects experience generation system 502 transforms a simple text prompt and cutout shape into a sophisticated window cutout image through multiple processing stages. By implementing this dual-pipeline approach with varying levels of enforcement, the system creates window cutout images that naturally integrate the cutout regions with the surrounding scene, providing an effective solution for generating content that can be used in social media experiences and other interactive applications.

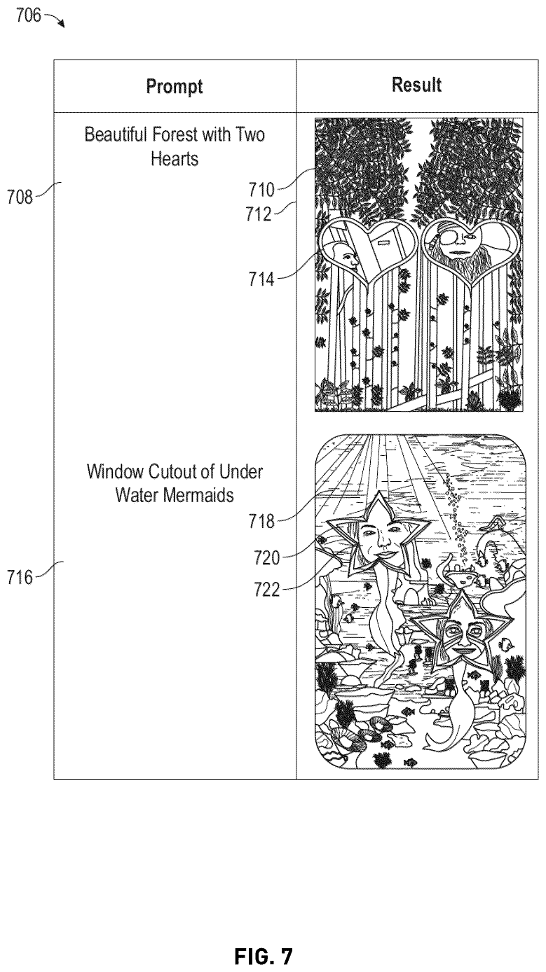

FIG. 7 is a diagram 706 of example inputs and outputs of the digital effects experience generation system 502, according to some examples. Specifically, FIG. 7 depicts a diagram 706 illustrating examples of the window cutout generation system's inputs and outputs, showcasing the dual-pipeline image generation process in action. The diagram 706 highlights how different text prompts can produce thematically diverse scenes with precisely integrated cutout regions designed for content placement. This approach combines image generation with cutout shape enforcement to create seamless, artistically coherent windows for inserting user content, such as faces or other media.

In the first example shown in diagram 706, the first prompt 708 “Beautiful forest with two hearts” initiates the generation process that ultimately results in the first final image 710. The digital effects experience generation system 502 processes this prompt through the ML component 506, which may enhance the descriptive details to guide the image generation process more effectively. The resulting image displays a lush forest environment with sunlight filtering through the trees, creating a serene natural setting that organically incorporates two heart-shaped cutout regions (e.g., first cutout region 712) among the foliage and tree trunks. These heart-shaped windows appear as natural elements within the forest scene rather than artificially imposed shapes, demonstrating how the dual-pipeline approach with varying enforcement levels creates visually coherent integration.

The first cutout region 712 is specifically designed to accommodate the first content item 714, which could be a real-time feed from a user's device camera showing their face, or alternatively, stored media content selected from their device library. The digital effect system 206 precisely crops these heart-shaped regions according to the defined cutout shape, creating transparent areas that function as windows into the content. When a user activates this experience, their face or selected content appears within these heart-shaped windows, creating the illusion that they are peering through heart-shaped openings in the forest scene. The digital effects experience generation system 502 ensures proper scaling and perspective so that the inserted content maintains visual harmony with the surrounding forest elements.

Initially, the digital effects experience generation system 502 generates the forest scene with a lighter enforcement of the heart shapes, allowing the natural elements of the forest to develop around where the hearts will ultimately appear. Then, through the edge map generation and modification process, the digital effects experience generation system 502 applies stronger enforcement of the heart shapes, ensuring they are precisely defined while maintaining their artistic integration with the surrounding trees, leaves, and forest floor. This progressive enforcement approach is key to creating cutout regions that appear as natural elements of the scene rather than artificial impositions.

The ability of the digital effects experience generation system 502 to create properly integrated cutout shapes extends beyond simple geometric forms like hearts. The second example in diagram 706 demonstrates this versatility through the second prompt 716 “Window Cutout of underwater mermaids.” This prompt triggers the generation of the second final image 718, which depicts a vibrant underwater environment complete with coral formations, aquatic plants, and filtered sunlight penetrating the water's surface. The underwater theme creates a completely different aesthetic from the forest scene, yet the window cutout integration principles remain equally effective, showcasing the system's adaptability across diverse visual contexts.

Within the underwater scene of the second final image 718, the second cutout region 720 takes the form of curved window shapes (or stars) that harmonize with the flowing, organic elements of the aquatic landscape. These curved windows appear as though they might be portals or openings in an underwater structure, maintaining the thematic consistency of the scene. The careful integration of these shapes demonstrates how the window cutout generation system adapts to different contextual requirements while maintaining the artistic integrity of the generated environment. The curved nature of these shapes contrasts with the heart shapes in the forest scene, illustrating how the system can handle various cutout geometries based on what best suits the thematic context.

The second cutout region 720 creates spaces within the underwater scene where users can place the second content item 722, which might be their face captured in real-time or pre-selected media content. The digital effect system 206 enables this real-time placement while maintaining proper perspective and lighting integration with the underwater environment. For instance, if a user's face is displayed in these regions, the digital effects experience generation system 502 applies appropriate lighting effects that match the bluish, filtered light characteristic of underwater scenes. This attention to lighting and perspective details ensures that the inserted content appears as a natural part of the underwater world rather than simply being pasted on top of it.

The technical implementation behind these examples demonstrates how the dual-pipeline approach with varying levels of cutout shape enforcement ensures proper integration of cutout regions with surrounding scene elements. In the initial generation phase, the digital effects experience generation system 502 creates an image with lighter enforcement of the cutout shape, allowing for natural arrangement of scene elements. The digital effects experience generation system 502 then processes this initial image to generate an edge map, which is combined with the cutout shape under stronger enforcement to create a modified edge map. This modified edge map guides the final image generation, ensuring precise definition of the cutout regions while maintaining artistic coherence with the surrounding environment. The result is a seamless integration between the generated scene and the cutout areas where user content will be displayed.

Beyond the technical processes, the digital effects experience generation system 502 offers creative possibilities for social media and messaging applications. Users can create personalized expressions by inserting themselves into thematically rich environments or combine their image with friends or other content in playful compositions. For example, using the forest scene, two friends could place their faces in the respective heart cutouts, creating a memorable shared visual moment. Similarly, the underwater mermaid scene could allow users to transform themselves into mythical sea creatures by placing their faces in the curved window (e.g., star) openings alongside underwater elements. These creative applications demonstrate how the technical sophistication of the window cutout generation system translates into engaging user experiences.

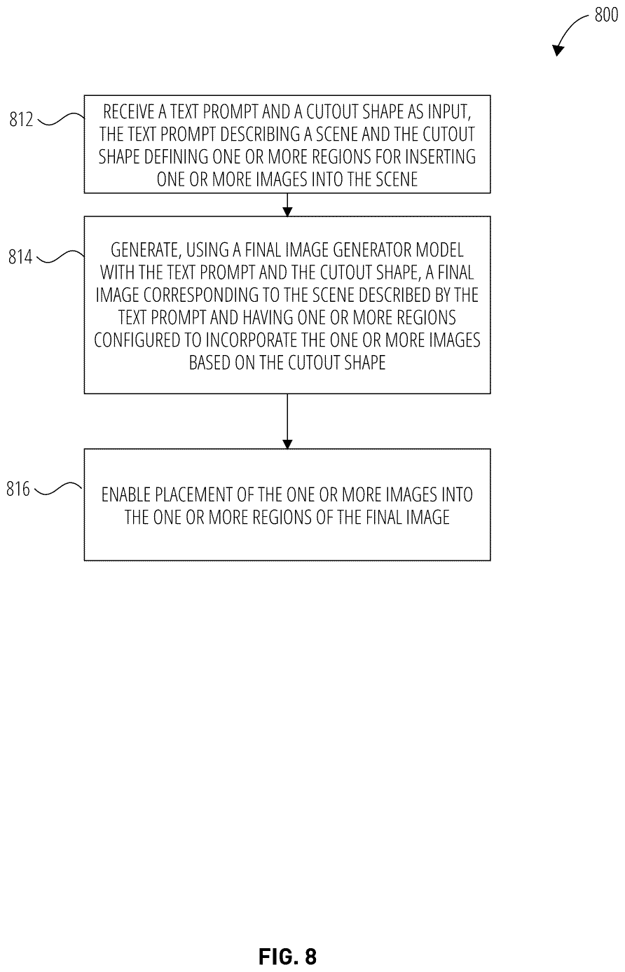

FIG. 8 is a flowchart illustrating a routine 800 (e.g., a method or process), according to some examples. Although the example method depicted in FIG. 8 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At operation 812, the digital effects experience generation system 502 receives a text prompt and a cutout shape as input, where the text prompt describes a scene and the cutout shape defines one or more regions for inserting one or more images into the scene.

At operation 814, the digital effects experience generation system 502 generates, using a final image generator model with the text prompt and the cutout shape, a final image corresponding to the scene described by the text prompt and having one or more regions configured to incorporate the one or more images based on the cutout shape. This operation involves processing the inputs through the dual-pipeline generation approach to create an image that naturally integrates the cutout regions with the surrounding scene elements.

At operation 816, the digital effects experience generation system 502 enables placement of the one or more images into the one or more regions of the final image. This operation allows users to insert content such as camera feeds or stored media into the transparent areas created by the cutout regions while maintaining proper perspective and lighting integration with the generated scene.

The routine 800 implements the core functionality of the digital effects experience generation system 502, transforming text descriptions and cutout shapes into integrated scenes with precisely defined regions for content placement.

### System with Head-Wearable Apparatus

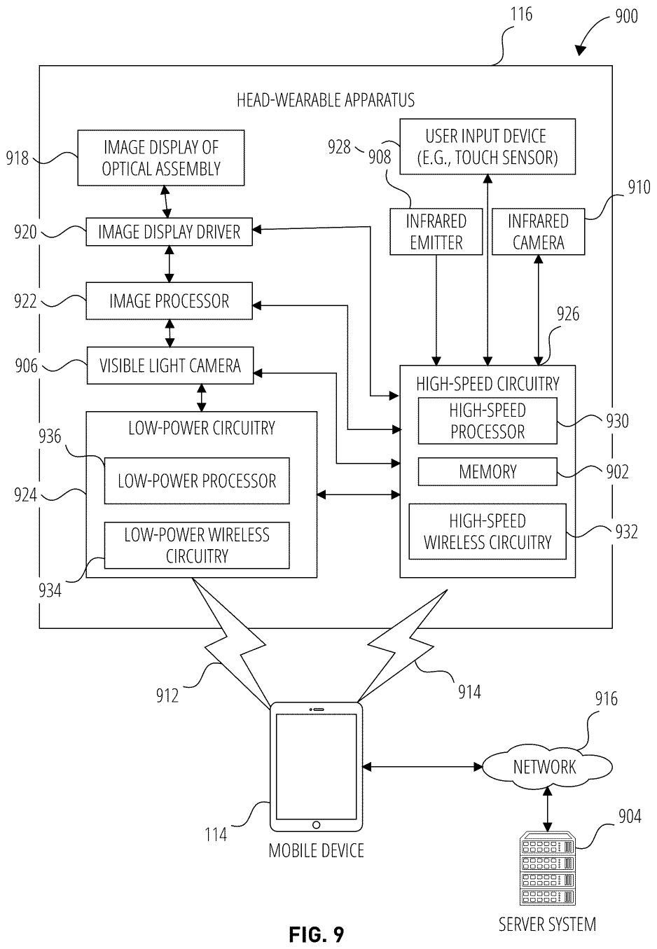

FIG. 9 illustrates a system 900 including a head-wearable apparatus 116 with a selector input device, according to some examples. FIG. 9 is a high-level functional block diagram of an example head-wearable apparatus 116 communicatively coupled to a mobile device 114 and various server systems 904 (e.g., the server system 110 of FIG. 1) via various networks.

The head-wearable apparatus 116 includes one or more cameras, each of which may be, for example, a visible light camera 906, an infrared emitter 908, and an infrared camera 910.

The mobile device 114 connects with head-wearable apparatus 116 using both a low-power wireless connection 912 and a high-speed wireless connection 914. The mobile device 114 is also connected to the server system 904 and the network 916.

The head-wearable apparatus 116 further includes two image displays of the image display of optical assembly 918. The two image displays of optical assembly 918 include one associated with the left lateral side and one associated with the right lateral side of the head-wearable apparatus 116. The head-wearable apparatus 116 also includes an image display driver 920, an image processor 922, low-power circuitry 924, and high-speed circuitry 926. The image display of optical assembly 918 is for presenting images and videos, including an image that can include a graphical user interface to a user of the head-wearable apparatus 116.

The image display driver 920 commands and controls the image display of optical assembly 918. The image display driver 920 may deliver image data directly to the image display of optical assembly 918 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 928 (e.g., touch sensor or push button), including an input surface on the head-wearable apparatus 116. The user input device 928 (e.g., touch sensor or push button) is to receive from the user an input selection to manipulate the graphical user interface of the presented image.

The components shown in FIG. 9 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 906 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 902, which stores instructions to perform a subset, or all the functions described herein. The memory 902 can also include storage device.

As shown in FIG. 9, the high-speed circuitry 926 includes a high-speed processor 930, a memory 902, and high-speed wireless circuitry 932. In some examples, the image display driver 920 is coupled to the high-speed circuitry 926 and operated by the high-speed processor 930 to drive the left and right image displays of the image display of optical assembly 918. The high-speed processor 930 may be any processor capable of managing high-speed communications and operation of any general computing system needed for the head-wearable apparatus 116. The high-speed processor 930 includes processing resources needed for managing high-speed data transfers on a high-speed wireless connection 914 to a wireless local area network (WLAN) using the high-speed wireless circuitry 932. In certain examples, the high-speed processor 930 executes an operating system such as a LINUX operating system or other such operating systems of the head-wearable apparatus 116, and the operating system is stored in the memory 902 for execution. In addition to any other responsibilities, the high-speed processor 930 executing a software architecture for the head-wearable apparatus 116 is used to manage data transfers with high-speed wireless circuitry 932. In certain examples, the high-speed wireless circuitry 932 is configured to implement Institute of Electrical and Electronic Engineers (IEEE) 802.11 communication standards, also referred to herein as WI-FI®. In some examples, other high-speed communications standards may be implemented by the high-speed wireless circuitry 932.

The low-power wireless circuitry 934 and the high-speed wireless circuitry 932 of the head-wearable apparatus 116 can include short-range transceivers (e.g., Bluetooth™, Bluetooth LE, Zigbee, ANT+) and wireless wide, local, or wide area Network transceivers (e.g., cellular or WI-FI®). Mobile device 114, including the transceivers communicating via the low-power wireless connection 912 and the high-speed wireless connection 914, may be implemented using details of the architecture of the head-wearable apparatus 116, as can other elements of the network 916.

The memory 902 includes any storage device capable of storing various data and applications, including, among other things, camera data generated by the left and right visible light cameras 906, the infrared camera 910, and the image processor 922, as well as images generated for display by the image display driver 920 on the image displays of the image display of optical assembly 918. While the memory 902 is shown as integrated with high-speed circuitry 926, in some examples, the memory 902 may be an independent standalone element of the head-wearable apparatus 116. In certain such examples, electrical routing lines may provide a connection through a chip that includes the high-speed processor 930 from the image processor 922 or the low-power processor 936 to the memory 902. In some examples, the high-speed processor 930 may manage addressing of the memory 902 such that the low-power processor 936 will boot the high-speed processor 930 any time that a read or write operation involving memory 902 is needed.

As shown in FIG. 9, the low-power processor 936 or high-speed processor 930 of the head-wearable apparatus 116 can be coupled to the camera (visible light camera 906, infrared emitter 908, or infrared camera 910), the image display driver 920, the user input device 928 (e.g., touch sensor or push button), and the memory 902.

The head-wearable apparatus 116 is connected to a host computer. For example, the head-wearable apparatus 116 is paired with the mobile device 114 via the high-speed wireless connection 914 or connected to the server system 904 via the Network 916. The server system 904 may be one or more computing devices as part of a service or network computing system, for example, that includes a processor, a memory, and network communication interface to communicate over the Network 916 with the mobile device 114 and the head-wearable apparatus 116.

The mobile device 114 includes a processor and a network communication interface coupled to the processor. The network communication interface allows for communication over the network 916, low-power wireless connection 912, or high-speed wireless connection 914. Mobile device 114 can further store at least portions of the instructions in the memory of the mobile device 114 memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 920. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 904, such as the user input device 928, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include sensors and display elements integrated with the head-wearable apparatus 116. For example, peripheral device elements may include any input/output (I/O) components including output components, motion components, position components, or any other such elements described herein.

In some examples, the head-wearable apparatus 116 may include biometric components or sensors s to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored with only user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

The motion components include acceleration sensor components (e.g., accelerometer), gravitation sensor components, rotation sensor components (e.g., gyroscope), and so forth. The position components include location sensor components to generate location coordinates (e.g., a GPS receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 912 and high-speed wireless connection 914 from the mobile device 114 via the low-power wireless circuitry 934 or high-speed wireless circuitry 932.

### Machine Architecture

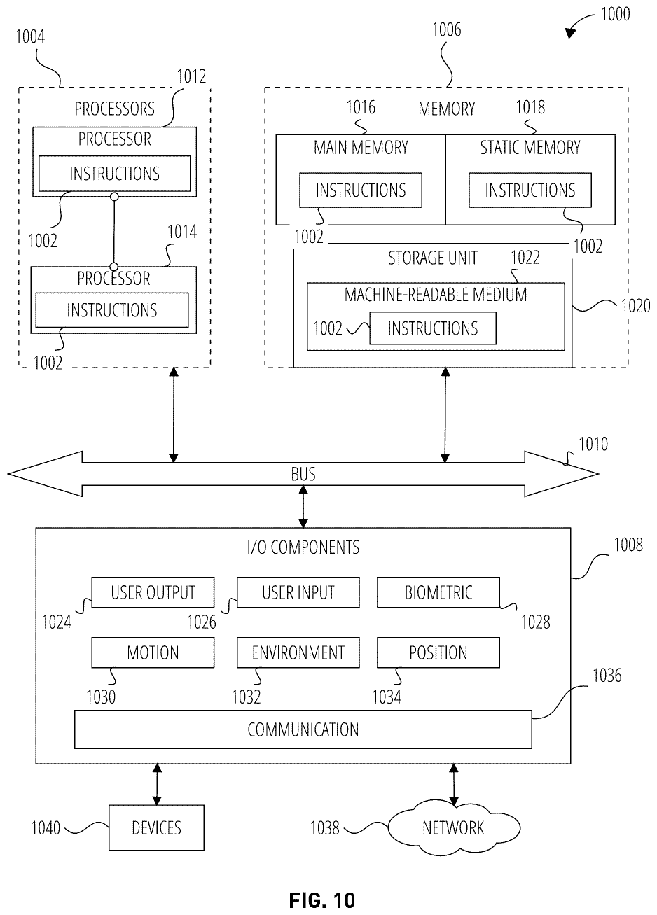

FIG. 10 is a diagrammatic representation of the machine 1000 within which instructions 1002 (e.g., software, a program, an application, an applet, an app, or other executable code) for causing the machine 1000 to perform any one or more of the methodologies discussed herein may be executed. For example, the instructions 1002 may cause the machine 1000 to execute any one or more of the methods described herein. The instructions 1002 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1002, sequentially or otherwise, that specify actions to be taken by the machine 1000. Further, while a single machine 1000 is illustrated, the term “machine” shall also be taken to include a collection of machines that individually or jointly execute the instructions 1002 to perform any one or more of the methodologies discussed herein. The machine 1000, for example, may comprise the user system 102 or any one of multiple server devices forming part of the server system 110. In some examples, the machine 1000 may also comprise both client and server systems, with certain operations of a particular method or algorithm being performed on the server-side and with certain operations of the method or algorithm being performed on the client-side.

The machine 1000 may include processors 1004, memory 1006, and I/O components 1008, which may be configured to communicate with each other via a bus 1010.

The memory 1006 includes a main memory 1016, a static memory 1018, and a storage unit 1020, both accessible to the processors 1004 (e.g., processor 1012 or processor 1014 via the bus 1010. The main memory 1006, the static memory 1018, and storage unit 1020 store the instructions 1002 embodying any one or more of the methodologies or functions described herein. The instructions 1002 may also reside, completely or partially, within the main memory 1016, within the static memory 1018, within machine-readable medium 1022 within the storage unit 1020, within at least one of the processors 1004 (e.g., within the processor's cache memory), or any suitable combination thereof, during execution thereof by the machine 1000.

The I/O components 1008 may include a wide variety of components to receive input, provide output, produce output, transmit information, exchange information, capture measurements, and so on. The specific I/O components 1008 that are included in a particular machine will depend on the type of machine. For example, portable machines such as mobile phones may include a touch input device or other such input mechanisms, while a headless server machine will likely not include such a touch input device. It will be appreciated that the I/O components 1008 may include many other components that are not shown in FIG. 10. In various examples, the I/O components 1008 may include user output components 1024 and user input components 1026. The user output components 1024 may include visual components (e.g., a display such as a PDP, a LED display, a LCD, a projector, or a cathode ray tube (CRT)), acoustic components (e.g., speakers), haptic components (e.g., a vibratory motor, resistance mechanisms), other signal generators, and so forth. The user input components 1026 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1008 may include biometric components 1028, motion components 1030, environmental components 1032, or position components 1034, among a wide array of other components. For example, the biometric components 1028 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a BMI system that allows communication between the brain and an external device or machine. This may be achieved by recording brain activity data, translating this data into a format that can be understood by a computer, and then using the resulting signals to control the device or machine.

The motion components 1030 include acceleration sensor components (e.g., accelerometer), gravitation sensor components, and rotation sensor components (e.g., gyroscope).

The environmental components 1032 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 1008 further include communication components 1036 operable to couple the machine 1000 to a network 1038 or devices 1040 via respective coupling or connections. For example, the communication components 1036 may include a network interface component or another suitable device to interface with the network 1038. In further examples, the communication components 1036 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1040 may be another machine or any of a wide variety of peripheral devices (e.g., a peripheral device coupled via a USB).

Moreover, the communication components 1036 may detect identifiers or include components operable to detect identifiers. For example, the communication components 1036 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1036, such as location via Internet Protocol (IP) geolocation, location via Wi-Fi® signal triangulation, location via detecting an NFC beacon signal that may indicate a particular location, and so forth.

The various memories (e.g., main memory 1016, static memory 1018, and memory of the processors 1004) and storage unit 1020 may store one or more sets of instructions and data structures (e.g., software) embodying or used by any one or more of the methodologies or functions described herein. These instructions (e.g., the instructions 1002), when executed by the processors 1004, cause various operations to implement the disclosed examples.

The instructions 1002 may be transmitted or received over the network 1038, using a transmission medium, via a network interface device (e.g., a network interface component included in the communication components 1036) and using any one of several well-known transfer protocols (e.g., HTTP). Similarly, the instructions 1002 may be transmitted or received using a transmission medium via a coupling (e.g., a peer-to-peer coupling) to the devices 1040.

### Software Architecture

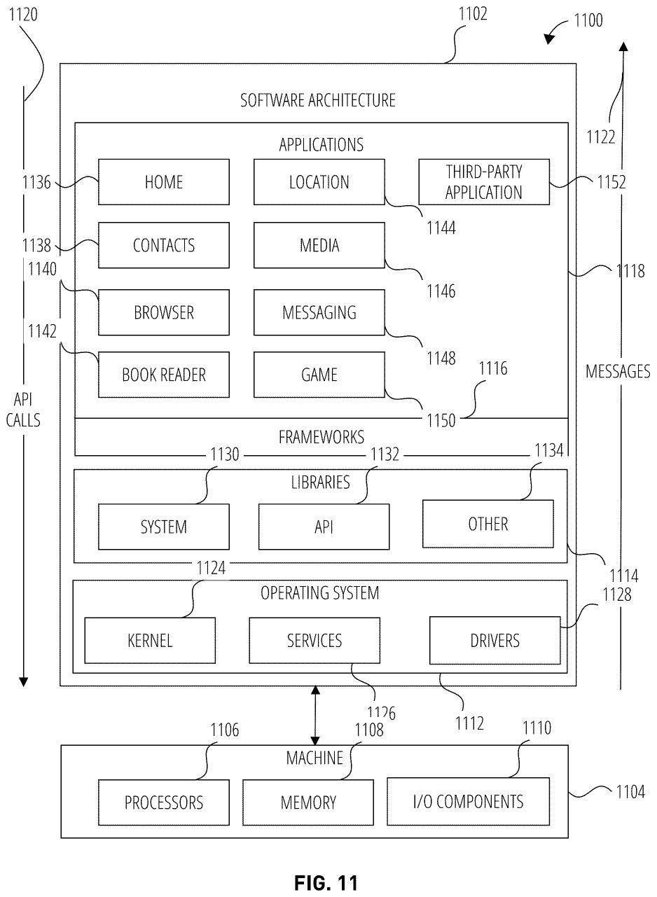

FIG. 11 is a block diagram 1100 illustrating a software architecture 1102, which can be installed on any one or more of the devices described herein. The software architecture 1102 is supported by hardware such as a machine 1104 that includes processors 1106, memory 1108, and I/O components 1110. In this example, the software architecture 1102 can be conceptualized as a stack of layers, where each layer provides a particular functionality. The software architecture 1102 includes layers such as an operating system 1112, libraries 1114, frameworks 1116, and applications 1118. Operationally, the applications 1118 invoke API calls 1120 through the software stack and receive messages 1122 in response to the API calls 1120.

The operating system 1112 manages hardware resources and provides common services. The operating system 1112 includes, for example, a kernel 1124, services 1126, and drivers 1128. The kernel 1124 acts as an abstraction layer between the hardware and the other software layers. For example, the kernel 1124 provides memory management, processor management (e.g., scheduling), component management, networking, and security settings, among other functionalities. The services 1126 can provide other common services for the other software layers. The drivers 1128 are responsible for controlling or interfacing with the underlying hardware. For instance, the drivers 1128 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1114 provide a common low-level infrastructure used by the applications 1118. The libraries 1114 can include system libraries 1130 (e.g., C standard library) that provide functions such as memory allocation functions, string manipulation functions, mathematical functions, and the like. In addition, the libraries 1114 can include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in 2D and 3D in a graphic content on a display), database libraries (e.g., SQLite to provide various relational database functions), web libraries (e.g., WebKit to provide web browsing functionality), and the like. The libraries 1114 can also include a wide variety of other libraries 1134 to provide many other APIs to the applications 1118.

The frameworks 1116 provide a common high-level infrastructure that is used by the applications 1118. For example, the frameworks 1116 provide various GUI functions, high-level resource management, and high-level location services. The frameworks 1116 can provide a broad spectrum of other APIs that can be used by the applications 1118, some of which may be specific to a particular operating system or platform.

In an example, the applications 1118 may include a home application 1136, a contacts application 1138, a browser application 1140, a book reader application 1142, a location application 1144, a media application 1146, a messaging application 1148, a game application 1150, and a broad assortment of other applications such as a third-party application 1152. The applications 1118 are programs that execute functions defined in the programs. Various programming languages can be employed to create one or more of the applications 1118, structured in a variety of manners, such as object-oriented programming languages (e.g., Objective-C, Java, or C++) or procedural programming languages (e.g., C or assembly language). In a specific example, the third-party application 1152 (e.g., an application developed using the ANDROID™ or IOS™ SDK by an entity other than the vendor of a platform) may be mobile software running on a mobile operating system such as IOS™, ANDROID™, WINDOWS® Phone, or another mobile operating system. In this example, the third-party application 1152 can invoke the API calls 1120 provided by the operating system 1112 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### Example Statements

Example 1. A system comprising: at least one processor; and at least one memory component storing instructions that, when executed by the at least one processor, cause the at least one processor to perform operations comprising: receiving a text prompt and a cutout shape as input, the text prompt describing a scene and the cutout shape defining one or more regions for inserting one or more images into the scene; generating, using a final image generator model with the text prompt and the cutout shape, a final image corresponding to the scene described by the text prompt and having one or more regions configured to incorporate the one or more images based on the cutout shape; and enabling placement of the one or more images into the one or more regions of the final image.

Example 2. The system of Example 1, wherein the operations further comprise: generating, by an initial image generator model with the text prompt and the cutout shape, an initial image representing the scene described by the text prompt.

Example 3. The system of Example 2, wherein the operations further comprise: processing the initial image to generate an edge map of the initial image; and combining the edge map with the cutout shape to create a modified edge map with enhanced definition of the one or more regions.

Example 4. The system of Example 3, wherein the operations further comprise: detecting edges within the initial image; and enhancing definition of the edges along boundaries of the one or more regions defined by the cutout shape to generate the modified edge map.

Example 5. The system of any one of Examples 3-4, wherein the operations further comprise: processing, by the final image generator model, the modified edge map, a second image that incorporates the one or more regions with stronger enforcement of the cutout shape than in the initial image.

Example 6. The system of Example 5, wherein the operations further comprise: cropping out the one or more regions from the second image to generate the final image.

Example 7. The system of any one of Examples 1-6, wherein the cutout shape comprises an edge map representing the cutout shape.

Example 8. The system of Example 7, wherein the edge map comprises a Canny image.

Example 9. The system of any one of Examples 1-8, wherein receiving the text prompt comprises: analyzing the text prompt using a large language model (LLM); and generating an enhanced text prompt that includes additional descriptive details related to the scene, the enhanced text prompt being processed by one or more image generators to generate the final image.

Example 10. The system of any one of Examples 1-9, wherein the cutout shape is selected from a library of predefined shapes.

Example 11. The system of Example 10, wherein the library of predefined shapes comprises at least one of: hearts, circles, stars, or custom user-defined shapes.

Example 12. The system of any one of Examples 1-11, wherein the operations further comprise: cropping the one or more regions of the final image according to the cutout shape to create transparent areas; and enabling display of content from a device camera through the transparent areas.

Example 13. The system of any one of Examples 12, wherein enabling placement of the one or more images comprises: capturing a live image from a camera of a user device; and displaying the live image within the one or more regions of the final image in real-time.

Example 14. The system of any one of Examples 1-13, wherein the operations further comprise: enabling selection of stored media content from a library; and placing the selected media content within the one or more regions of the final image.

Example 15. The system of any one of Examples 1-14, wherein the cutout shape defines multiple non-contiguous regions for inserting multiple separate images into the scene.

Example 16. The system of any one of Examples 1-15, wherein generating the final image comprises: creating a scribble representation of the cutout shape; and using the scribble representation as input to the final image generator model to influence arrangement of scene elements around the one or more regions.

Example 17. The system of any one of Examples 1-16, wherein the operations further comprise: generating multiple variations of the final image using the same text prompt and cutout shape; and enabling user selection from among the multiple variations.

Example 18. A computer-implemented method comprising: receiving a text prompt and a cutout shape as input, the text prompt describing a scene and the cutout shape defining one or more regions for inserting one or more images into the scene; generating, using a final image generator model with the text prompt and the cutout shape, a final image corresponding to the scene described by the text prompt and having one or more regions configured to incorporate the one or more images based on the cutout shape; and enabling placement of the one or more images into the one or more regions of the final image.

Example 19. A non-transitory computer-readable storage medium storing instructions that, when executed by at least one processor, cause the at least one processor to perform operations comprising: receiving a text prompt and a cutout shape as input, the text prompt describing a scene and the cutout shape defining one or more regions for inserting one or more images into the scene; generating, using a final image generator model with the text prompt and the cutout shape, a final image corresponding to the scene described by the text prompt and having one or more regions configured to incorporate the one or more images based on the cutout shape; and enabling placement of the one or more images into the one or more regions of the final image.

Example 20. The non-transitory computer-readable storage medium of clause 19, wherein the operations comprise: generating, by an initial image generator model with the text prompt and the cutout shape, an initial image representing the scene described by the text prompt.

### Term Examples

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a network to obtain resources from one or more server systems or other client devices. A client device may be, but is not limited to, a mobile phone, desktop computer, laptop, PDA, smartphone, tablet, ultrabook, netbook, laptop, multi-processor system, microprocessor-based or programmable consumer electronics, game console, STB, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations.

A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time.

For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein.

As used herein, “processor-implemented component” may refer to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), FPGA, flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, Network Attached Storage (NAS), Storage Area Networks (SAN), and object storage devices. The terms “machine-storage medium,” “device-storage medium,” and “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a WLAN, a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. A system comprising:
at least one processor; and
at least one memory component storing instructions that, when executed by the at least one processor, cause the at least one processor to perform operations comprising:
receiving a text prompt and a cutout shape as input, the text prompt describing a scene and the cutout shape defining one or more regions for inserting one or more images into the scene;
generating, using a final image generator with the text prompt and the cutout shape, a final image corresponding to the scene described by the text prompt and having one or more regions configured to incorporate the one or more images based on the cutout shape; and
enabling placement of the one or more images into the one or more regions of the final image.

2. The system of claim 1, wherein the operations further comprise:
generating, by an initial image generator with the text prompt and the cutout shape, an initial image representing the scene described by the text prompt.

3. The system of claim 2, wherein the operations further comprise:
processing the initial image to generate an edge map of the initial image; and
combining the edge map with the cutout shape to create a modified edge map with enhanced definition of the one or more regions.

4. The system of claim 3, wherein the operations further comprise:
detecting edges within the initial image; and
enhancing definition of the edges along boundaries of the one or more regions defined by the cutout shape to generate the modified edge map.

5. The system of claim 3, wherein the operations further comprise:
processing, by the final image generator, the modified edge map, a second image that incorporates the one or more regions with stronger enforcement of the cutout shape than in the initial image.

6. The system of claim 5, wherein the operations further comprise:
cropping out the one or more regions from the second image to generate the final image.

7. The system of claim 1, wherein the cutout shape comprises an edge map representing the cutout shape.

8. The system of claim 7, wherein the edge map comprises a Canny image.

9. The system of claim 1, wherein receiving the text prompt comprises:
analyzing the text prompt using a large language model (LLM); and
generating an enhanced text prompt that includes additional descriptive details related to the scene, the enhanced text prompt being processed by one or more image generators to generate the final image.

10. The system of claim 1, wherein the cutout shape is selected from a library of predefined shapes.

11. The system of claim 10, wherein the library of predefined shapes comprises at least one of: hearts, circles, stars, or custom user-defined shapes.

12. The system of claim 1, wherein the operations further comprise:
cropping the one or more regions of the final image according to the cutout shape to create transparent areas; and
enabling display of content from a device camera through the transparent areas.

13. The system of claim 1, wherein enabling placement of the one or more images comprises:
capturing a live image from a camera of a user device; and
displaying the live image within the one or more regions of the final image in real-time.

14. The system of claim 1, wherein the operations further comprise:
enabling selection of stored media content from a library; and
placing the selected media content within the one or more regions of the final image.

15. The system of claim 1, wherein the cutout shape defines multiple non-contiguous regions for inserting multiple separate images into the scene.

16. The system of claim 1, wherein generating the final image comprises:
creating a scribble representation of the cutout shape; and
using the scribble representation as input to the final image generator to influence arrangement of scene elements around the one or more regions.

17. The system of claim 1, wherein the operations further comprise:
generating multiple variations of the final image using the same text prompt and cutout shape; and
enabling user selection from among the multiple variations.

18. A computer-implemented method comprising:
receiving a text prompt and a cutout shape as input, the text prompt describing a scene and the cutout shape defining one or more regions for inserting one or more images into the scene;
generating, using a final image generator with the text prompt and the cutout shape, a final image corresponding to the scene described by the text prompt and having one or more regions configured to incorporate the one or more images based on the cutout shape; and
enabling placement of the one or more images into the one or more regions of the final image.

19. A non-transitory computer-readable storage medium storing instructions that, when executed by at least one processor, cause the at least one processor to perform operations comprising:
receiving a text prompt and a cutout shape as input, the text prompt describing a scene and the cutout shape defining one or more regions for inserting one or more images into the scene;
generating, using a final image generator with the text prompt and the cutout shape, a final image corresponding to the scene described by the text prompt and having one or more regions configured to incorporate the one or more images based on the cutout shape; and
enabling placement of the one or more images into the one or more regions of the final image.

20. The non-transitory computer-readable storage medium of claim 19, wherein the operations comprise:
generating, by an initial image generator with the text prompt and the cutout shape, an initial image representing the scene described by the text prompt.
